(19) United States
(12) Patent Application Publication
(10) Pub. No.: US 2017/0300633 A1
(43) Pub. Date: Oct. 19, 2017

(54) ONLINE PROVISIONING FOR ELECTRONIC MEDICAL RECORDS

(71) Applicant: The Regents of the University of California, Oakland, CA (US)

(72) Inventors: Joshua A. Simon, Sacramento, CA (US); Carlos Aguilar, Elk Grove, CA (US); Gloria Estela Ayala, Sacramento, CA (US); Desiree N. Garcia, Sacramento, CA (US); Erol Layiktez, Woodland, CA (US); Monica Moldovan, Rocklin, CA (US); John L. Nystrom, Sacramento, CA (US); Mark C. Sy, Sacramento, CA (US)

(73) Assignee: The Regents of the University of California, Oakland, CA (US)

(21) Appl. No.: 15/489,580

(22) Filed: Apr. 17, 2017

Related U.S. Application Data
(60) Provisional application No. 62/324,096, filed on Apr. 18, 2016.

(51) Int. Cl. G06F 19/00; H04L 29/06

(52) U.S. Cl. CPC G06F 19/322; G06F 19/328; H04L 63/10

(57) ABSTRACT

The disclosed embodiments relate to the design of a system that manages access rights for an EMR system. During operation, the system receives a request to provision access rights for a user of the EMR system. In response to the request, the system performs a mapping operation that checks the request against attributes of the user to determine the user's access rights in the EMR system. If the request generates an exception, the system presents the request to an analyst to handle the exception. If the request does not generate an exception, the system automatically approves the request.

### CROSS-REFERENCE TO RELATED APPLICATION

This application claims priority under 35 U.S.C. §119(e) to U.S. Provisional Application Ser. No. 62/324,096, entitled “Online Provisioning for Electronic Medical Records,” by inventors Joshua Simon, et al., Attorney Docket Number UC15-635-1PSP, filed on 18 Apr. 2016, the contents of which are incorporated by reference herein.

### BACKGROUND

### Field

The disclosed embodiments generally relate to electronic health record (EHR) systems. More specifically, the disclosed embodiments relate to an online provisioning system for electronic medical records that manages access-rights to an EHR system based on user's role, job functions and credentials.

### Related Art

As part of the Health Insurance Portability and Accountability Act (HIPAA) requirements, a medical center must implement access-controls to ensure that all accesses to electronic medical records (EMRs) and associated actions performed by medical center staff comply with HIPAA standards.

However, there exist a number of factors, which make it challenging to implement the required role-based access-controls. First, large medical centers often employ hundreds or thousands of staff members, which means that employee records for staff members change on a daily basis as staff members periodically, join, leave or change jobs within the organization. These changing employee records typically involve corresponding changes to the access roles of the employees, and the role-based access-control system must effectively keep track of these changes. Moreover, in a clinical setting, these roles must be updated as fast as possible, because a health care clinician may need to access medical records or prescribe medication without delay to treat a patient who requires immediate care.

Hence, what is needed is an access-control system for medical records that can effectively update user roles in a timely manner.

### SUMMARY

The disclosed embodiments relate to the design of a system that manages access rights for an EMR system. During operation, the system receives a request to provision access rights for a user of the EMR system. In response to the request, the system performs a mapping operation that checks the request against attributes of the user to determine the user's access rights in the EMR system. If the request generates an exception, the system presents the request to an analyst to handle the exception. If the request does not generate an exception, the system automatically approves the request.

In some embodiments, after the request has been approved, the system propagates the determined access rights to the EMR system to facilitate compliance with Health Insurance Portability and Accountability Act (HIPAA) access-control requirements.

In some embodiments, the request comprises one of the following: a request for a renewal for the user; a request for a revocation of the user; and a request that is automatically generated during an account-maintenance operation.

In some embodiments, the attributes used during the mapping operation include one or more of the following: the user's role in the EMR system; the user's job functions; and the user's provider/medical credentials.

In some embodiments, in response to the request, the system validates data items associated with the request for accuracy and consistency against copies of the data items obtained from ancillary systems.

In some embodiments, the system assigns priorities to received requests, so that higher-priority requests are processed before lower-priority requests based on the type of user the request is for, such as Patient Care roles versus administrative.

In some embodiments, the system updates a user's access rights automatically without delay in response to changes in data associated with the user, wherein the data changes are automatically obtained from one or more of the following computer systems: a human resources (HR) system; a health care provider credentialing system; an access-management system; an electronic healthcare record system; and a system that supports an active directory service.

In some embodiments, the system performs a duplicate-analysis operation to ensure that a duplicate account is not provisioned for a user.

In some embodiments, the system performs auditing operations to comply with HIPAA requirements.

In some embodiments, the system performs reporting operations to comply with HIPAA requirements.

### BRIEF DESCRIPTION OF THE FIGURES

FIG. 1 illustrates an EHR system that supports online provisioning for electronic medical records in accordance with the disclosed embodiments.

FIG. 2 illustrates different avenues for receiving access requests in accordance with the disclosed embodiments.

FIG. 3 presents a flow chart illustrating operations performed by the online provisioning system in accordance with the disclosed embodiments.

FIG. 4 illustrates a computer system on which the online provisioning system executes in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

The disclosed embodiments relate to the design of a computer-based provisioning system that automatically grants access rights and security clearances to a user based on the user's roles, job functions and credentials. During this process, the provisioning system determines the appropriate level of access for a user, which depends on the user's needs and credentials. This system can handle provisioning for employees, contractors, vendors, community physicians and their staff, wherein employees are provisioned automatically, external users require a sponsor who interacts with the system to approve their access, and community providers are given access based on their credentials.

Unlike existing provisioning systems, which require manual entry of requests and associated data, the disclosed system processes access requests automatically and transmits user records directly to an EHR server, thereby creating accounts without human intervention. During this automated provisioning process, inputs are cross-checked against multiple data sources as necessary, and the system automatically assigns the request to an analyst for review when an exception condition or a data conflict arises. Moreover, this provisioning system is highly extensible, thereby accommodating new and expanded business rules, as well as policy and/or regulatory changes.

This automated provisioning system is described in more detail below.

### Implementation Details

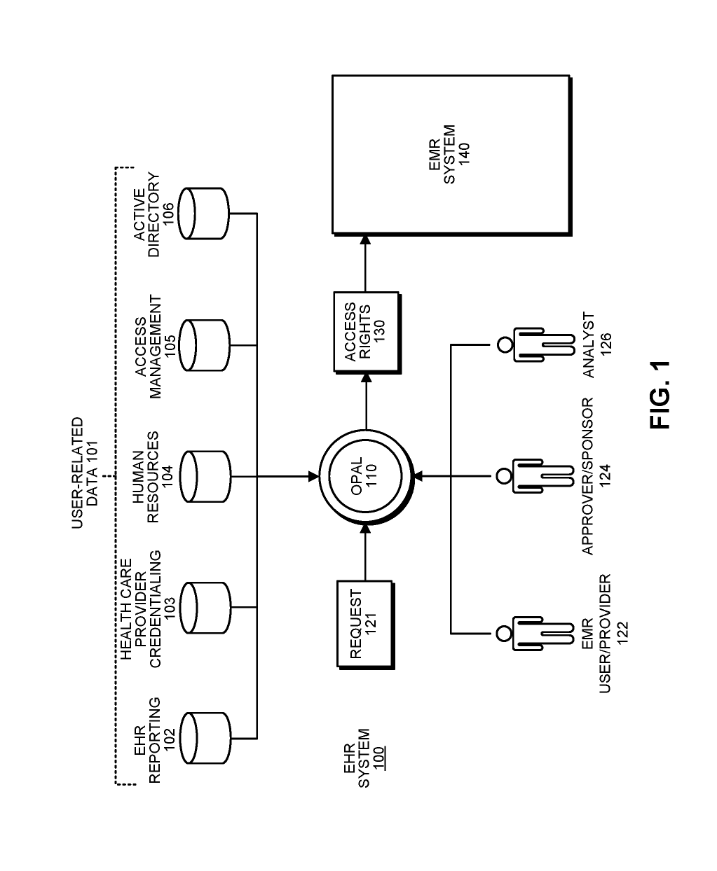

FIG. 1 illustrates an exemplary EHR system 100 in accordance with the disclosed embodiments. As illustrated in FIG. 1, EHR system 100 includes an online provisioning system for electronic medical records (referred to as “OPAL”) 110. OPAL 110 obtains user-related data 101 from various computer systems. More specifically, this user-related data 101 originates from: EHR reporting database 102, health care provider credentialing database 103, human resources (HR) database 104, access-management database 105, and active directory 106. OPAL 110 connects to the EHR reporting database 102 to check for duplicate accounts, identify upcoming renewals and extract information about the available user templates. OPAL 110 accesses health care provider credentialing database 103 to enable the system to determine which ordering and signing privileges users and providers are allowed to have in EHR system 100. The health care provider credentialing database 103 contains information indicating whether licenses are valid, and also whether providers have lost their privileges. HR database 104 includes employee records, which include various information, such as an employee's demographics, job code, cost centers and current job status (active or terminated). Access management database 105 contains information related to access rights for users. Active directory 106 is periodically polled to determine whether the user has access to the network, and also synchronizes a user's network login credentials with the user's EHR login credentials. Note that OPAL 110 manages active directory accounts for both local users, and remote users, such as Epic Community Connect™ and EpicCare Link™ users.

The received user-related data 101 provides sufficient information to allow OPAL 110 to: (1) determine a user's access rights; (2) perform provider licensing operations; (3) perform reporting operations; and (4) perform account-maintenance operations, including access revokes.

During operation, the system 100 illustrated in FIG. 1 receives a request 121 to provision access rights for a user of EMR system 140. While approving request 121, OPAL 110 can interact with various people or entities, including: (1) an EMR user/provider 122, (2) an approver/sponsor 124, and (3) an analyst 126. Finally, OPAL 110 outputs the user's access rights 130 to EMR system 140, so that EMR system 140 can comply with HIPAA access-control requirements.

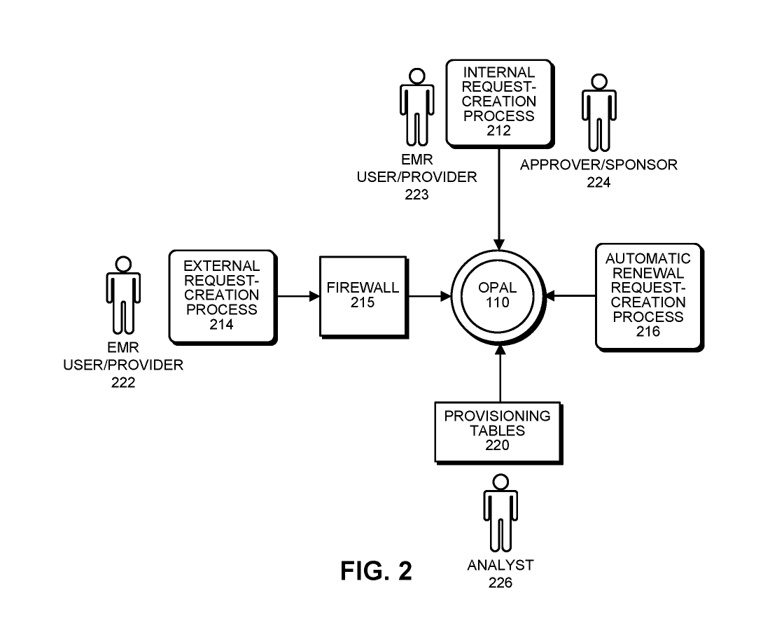

As illustrated in FIG. 2, request 121 can originate from a number of different sources. Request 121 can be generated outside of EHS system 100 through an external request-creation process 214 involving an EMR user/provider 222. Note that this externally generated request must pass through a firewall 215 before propagating to OPAL 110. Request 121 can also be generated through an internal-request creation process 212 involving an EMR user/provider 223 and an approver/sponsor 224. Request 121 can additionally be generated through an automatic renewal request-creation process 216. For example, it may be necessary for a non-employee to renew their access rights every 12 months; this type of renewal can be automatically initiated by automatic renewal request-creation process 216.

FIG. 2 additionally illustrates how provisioning tables 220 can be used by OPAL 110 to make decisions based on the user-related data 101 obtained from various sources and stored in provisioning tables 220, wherein user-related data 101 can include HR system data, credentialing data, EHR reporting data, etc. These provisioning tables 220 comprise lookup tables containing mappings, which enable OPAL 110 to make decisions based on the HR data, credentialing data and EHR data. Note that provisioning tables 220 contain values for each possible combination of job code, cost center, licensure, and user department. Based on these values, OPAL 110 automatically assigns the correct user template and provider privileges to a user. Note that provisioning tables 220 can be maintained by an analyst 226.

Once request 121 has been received by OPAL 110, the system runs through a series of logic checks, including the following: (1) priority determination—the system identifies which requests should have higher priority and assigns them to the top of a work queue, so that treating physicians and their care teams receive top priority; (2) duplication analysis—the system checks each import to ensure that the user does not currently exist in the system; (3) validation—the system checks all data elements against data in ancillary systems to verify accuracy and consistency; (4) provisioning mapping—requested information is cross-checked against a custom-built provisioning table, wherein user demographic information is used to determine the appropriate access rights; (5) request assignment—the system assigns each request to an analyst; and (6) exception handling—if any of the above-listed checks run into a problem, the system throws an exception for the problem, and the exception is assigned to an analyst who works to resolve the exception. Once all the exceptions have been cleared, OPAL 110 generates an import file containing the determined access rights 130 and pushes the import file to the EMR system 140. EMR system 140 then consumes the files and updates the access levels as needed.

### Account-Maintenance Operations

The OPAL system 110 can also perform various account-maintenance operations, which are described below.

Renewals and Revokes—

According to many hospital policies, non-employee accounts must be renewed every year. OPAL 110 identifies users that are up for renewal and takes steps to ensure that their accounts are not deactivated. It also sends a communication to the sponsor and asks them to confirm that continuing access is appropriate. If continuing access is not appropriate, OPAL 110 will revoke the user instead of renewing the user.

Proactive Leveling—

As users change job functions and roles, OPAL 110 identifies the changes, and reevaluates the access rights for the users in light of the changes. If the system determines that a user or a provider's licensure has changed, OPAL 110 will update the user or provider's access-rights automatically. This facilitates continuing compliance with local, state and Federal laws.

Semi-Annual Validation and Verification—

To further ensure compliance with an organization's regulations, all users are validated twice a year. To accomplish this, OPAL 110 can send an email to the user's manager/sponsor and can ask them to validate the user's access rights.

Administrative User Management—

In addition to normal user access rights, OPAL 110 manages administrative user accounts in a manner similar to the semi-annual validation process. For example, OPAL 110 can ensure that operations performed by administrative users comply with an organization's regulations, and that administrative users are periodically validated.

### Operation of Online Provisioning System

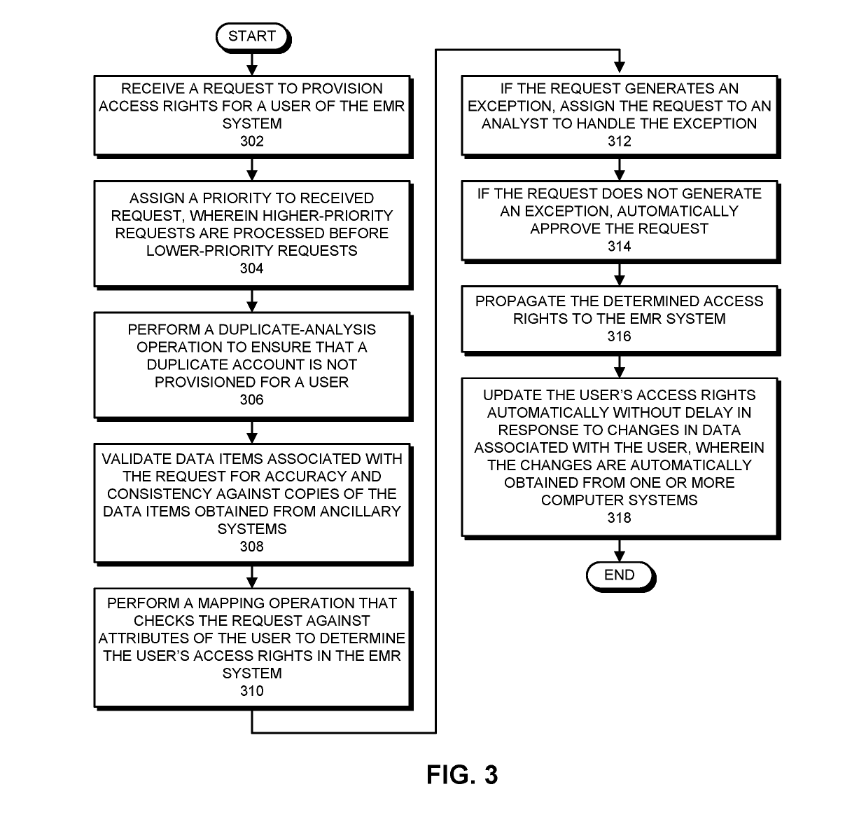

FIG. 3 presents a flow chart illustrating operation of the online provisioning system in accordance with the disclosed embodiments. First, the system receives a request to provision access rights for a user of the EMR system (step 302). Next, the system assigns a priority to received requests, wherein higher-priority requests are processed before lower-priority requests (step 304). The system also performs a duplicate-analysis operation to ensure that a duplicate account is not provisioned for a user (step 306). The system additionally validates data items associated with the request for accuracy and consistency against copies of the data items obtained from ancillary systems (step 308). Next, the system performs a mapping operation that checks the request against attributes of the user to determine the user's access rights in the EMR system (step 310). If the request generates an exception, the system assigns the request to an analyst to handle the exception (step 312). If the request does not generate an exception, the system automatically approves the request (step 314). Next, the system propagates the determined access rights to the EMR system (step 316). Finally, the system updates the user's access rights automatically without delay in response to changes in data associated with the user, wherein the changes are automatically obtained from one or more external computer systems (step 318).

### System

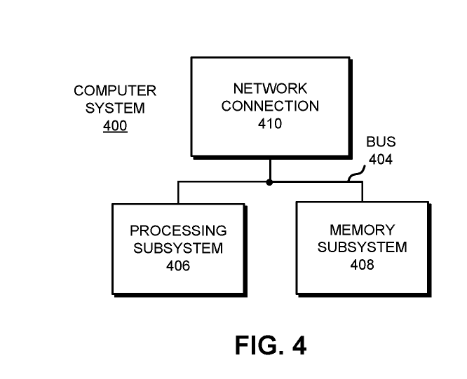

The embodiment of OPAL 110 illustrated in FIG. 1 can execute on a system or device. More specifically, FIG. 4 illustrates such an exemplary system 400 that includes: a processing subsystem 406 with one or more processors, a memory subsystem 408 (with memory), and a network connection 410, which is coupled to an external network.

In general, system 400 can be implemented using a combination of hardware and/or software. Thus, system 400 may include one or more program modules or sets of instructions stored in a memory subsystem 408 (such as DRAM or another type of volatile or non-volatile computer-readable memory), which, during operation, may be executed by processing subsystem 406. Furthermore, instructions in the various modules in memory subsystem 408 may be implemented in: a high-level procedural language, an object-oriented programming language, and/or in an assembly or machine language. Note that the programming language may be compiled or interpreted, e.g., configurable or configured, to be executed by the processing subsystem.

Components in system 400 may be coupled by signal lines, links or buses, for example bus 404. These connections may include electrical, optical, or electro-optical communication of signals and/or data. Furthermore, in the preceding embodiments, some components are shown directly connected to one another, while others are shown connected via intermediate components. In each instance, the method of interconnection, or “coupling,” establishes some desired communication between two or more circuit nodes, or terminals. Such coupling may often be accomplished using a number of photonic or circuit configurations, as will be understood by those of skill in the art; for example, photonic coupling, AC coupling and/or DC coupling may be used.

In some embodiments, functionality in these circuits, components and devices may be implemented in one or more: application-specific integrated circuits (ASICs), field-programmable gate arrays (FPGAs), and/or one or more digital signal processors (DSPs). Furthermore, functionality in the preceding embodiments may be implemented more in hardware and less in software, or less in hardware and more in software, as is known in the art. In general, system 400 may be at one location or may be distributed over multiple, geographically dispersed locations.

System 400 may include: a switch, a hub, a bridge, a router, a communication system (such as a wavelength-division-multiplexing communication system), a storage area network, a data center, a network (such as a local area network), and/or a computer system (such as a multiple-core processor computer system). Furthermore, the computer system may include, but is not limited to: a server (such as a multi-socket, multi-rack server), a laptop computer, a communication device or system, a personal computer, a work station, a mainframe computer, a blade, an enterprise computer, a data center, a tablet computer, a supercomputer, a network-attached-storage (NAS) system, a storage-area-network (SAN) system, a media player (such as an MP3 player), an appliance, a subnotebook/netbook, a tablet computer, a smartphone, a cellular telephone, a network appliance, a set-top box, a personal digital assistant (PDA), a toy, a controller, a digital signal processor, a game console, a device controller, a computational engine within an appliance, a consumer-electronic device, a portable computing device or a portable electronic device, a personal organizer, and/or another electronic device.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for managing access rights for an electronic medical records (EMR) system, comprising:
receiving a request to provision access rights for a user of the EMR system; and
in response to the request,
performing a mapping operation that checks the request against attributes of the user to determine the user's access rights in the EMR system;
if the request generates an exception, presenting the request to an analyst to handle the exception; and
if the request does not generate an exception, automatically approving the request.

2. The method of claim 1, wherein after the request has been approved, the method further comprises propagating the determined access rights to the EMR system to facilitate compliance with Health Insurance Portability and Accountability Act (HIPAA) access-control requirements.

3. The method of claim 1, wherein the request comprises one of the following:
a request for a renewal for the user;
a request for a revocation of the user; and
a request that is automatically generated during an account-maintenance operation.

4. The method of claim 1, wherein the attributes used during the mapping operation include one or more of the following:
the user's role in the EMR system;
the user's job functions; and
the user's provider/medical credentials.

5. The method of claim 1, wherein the method further comprises, in response to the request, validating data items associated with the request for accuracy and consistency against copies of the data items obtained from ancillary systems.

6. The method of claim 1, wherein the method further comprises assigning priorities to received requests, so that higher-priority requests are processed before lower-priority requests.

7. The method of claim 1, wherein the method further comprises updating a user's access rights automatically without delay in response to changes in data associated with the user, wherein the changes are automatically obtained from one or more of the following computer systems:
a human resources (HR) system;
a health care provider credentialing system;
an access-management system;
an electronic healthcare record system; and
a system that supports an active directory service.

8. The method of claim 1, wherein the method further comprises performing a duplicate-analysis operation to ensure that a duplicate account is not provisioned for a user.

9. The method of claim 1, wherein the method further comprises performing auditing operations to comply with HIPAA requirements.

10. The method of claim 1, wherein the method further comprises performing reporting operations to comply with HIPAA requirements.

11. A non-transitory computer-readable storage medium storing instructions that when executed by a computer cause the computer to perform a method for managing access rights for an electronic medical records (EMR) system, the method comprising:
receiving a request to provision access rights for a user of the EMR system; and
in response to the request,
performing a mapping operation that checks the request against attributes of the user to determine the user's access rights in the EMR system;
if the request generates an exception, presenting the request to an analyst to handle the exception; and
if the request does not generate an exception, automatically approving the request.

12. The non-transitory computer-readable storage medium of claim 11, wherein after the request has been approved, the method further comprises propagating the determined access rights to the EMR system to facilitate compliance with Health Insurance Portability and Accountability Act (HIPAA) access-control requirements.

13. The non-transitory computer-readable storage medium of claim 11, wherein the request comprises one of the following:
a request for a renewal for the user;
a request for a revocation of the user; and
a request that is automatically generated during an account-maintenance operation.

14. The non-transitory computer-readable storage medium of claim 11, wherein the attributes used during the mapping operation include one or more of the following:
the user's role in the EMR system;
the user's job functions; and
the user's provider/medical credentials.

15. The non-transitory computer-readable storage medium of claim 11, wherein the method further comprises, in response to the request, validating data items associated with the request for accuracy and consistency against copies of the data items obtained from ancillary systems.

16. The non-transitory computer-readable storage medium of claim 11, wherein the method further comprises assigning priorities to received requests, so that higher-priority requests are processed before lower-priority requests.

17. The non-transitory computer-readable storage medium of claim 11, wherein the method further comprises updating a user's access rights automatically without delay in response to changes in data associated with the user, wherein the changes are automatically obtained from one or more of the following computer systems:
a human resources (HR) system;
a health care provider credentialing system;
an access-management system;
an electronic healthcare record system; and
a system that supports an active directory service.

18. The non-transitory computer-readable storage medium of claim 11, wherein the method further comprises performing a duplicate-analysis operation to ensure that a duplicate account is not provisioned for a user.

19. The non-transitory computer-readable storage medium of claim 11, wherein the method further comprises performing auditing operations to comply with HIPAA requirements.

20. The non-transitory computer-readable storage medium of claim 11, wherein the method further comprises performing reporting operations to comply with HIPAA requirements.

21. A system that manages access rights for an electronic medical records (EMR) system, comprising:
at least one processor; and
a memory coupled to the at least one processor;
wherein the at least one processor executes program code stored on a non-transitory computer-readable storage medium, wherein the program code includes:
instructions for receiving a request to provision access rights for a user of the EMR system;
instructions for performing a mapping operation that checks the request against attributes of the user to determine the user's access rights in the EMR system;
instructions for presenting the request to an analyst to handle the exception if the request generates an exception; and
instructions for automatically approving the request if the request does not generate an exception.

22. The system of claim 21, wherein the program code additionally includes instructions for propagating the determined access rights to the EMR system after the request has been approved to facilitate compliance with Health Insurance Portability and Accountability Act (HIPAA) access-control requirements.

23. The system of claim 21, wherein the request comprises one of the following:
a request for a renewal for the user;
a request for a revocation of the user; and
a request that is automatically generated during an account-maintenance operation.

24. The system of claim 21, wherein the attributes used during the mapping operation include one or more of the following:
the user's role in the EMR system;
the user's job functions; and
the user's provider/medical credentials.

25. The system of claim 21, wherein the program code additionally includes instructions for validating data items associated with the request for accuracy and consistency against copies of the data items obtained from ancillary systems.

26. The system of claim 21, wherein the program code additionally includes instructions for assigning priorities to received requests, so that higher-priority requests are processed before lower-priority requests.

27. The system of claim 21, wherein the program code additionally includes instructions for updating a user's access rights automatically without delay in response to changes in data associated with the user, wherein the changes are automatically obtained from one or more of the following computer systems:
a human resources (HR) system;
a health care provider credentialing system;
an access-management system;
an electronic healthcare record system; and
a system that supports an active directory service.

28. The system of claim 21, wherein the program code additionally includes instructions for performing a duplicate-analysis operation to ensure that a duplicate account is not provisioned for a user.

29. The system of claim 21, wherein the program code additionally includes instructions for performing auditing operations to comply with HIPAA requirements.

30. The system of claim 21, wherein the program code additionally includes instructions for performing reporting operations to comply with HIPAA requirements.
